(19) United States
(12) Patent Application Publication
(10) Pub. No.: US 2003/0176593 A1
(43) Pub. Date: Sep. 18, 2003

(54) Building material comprising a fibrous or filament reinforcement

(76) Inventors: Bertrand Bordes, Vienne (FR); Gilles Orange, Soisy Sous Montmorency (FR); Jean-Franccois Sassi, Saint-Romain En Jarez (FR)

Correspondence Address: Jean-Louis Seugnet, Rhodia Inc, Intellectual Property Deparment, 259 Prospect Plains Road CN 7500, Cranbury, NJ, 08512-7500, US

(21) Appl. No.: 10/344,026

(22) PCT Filed: Aug. 9, 2001
(86) PCT No.: PCT/FR01/02585

(30) Foreign Application Priority Data
Aug. 9, 2000 (FR) 00/10487

(51) Int. Cl. C08G 63/91

(52) U.S. Cl. 525/419

(57) ABSTRACT

The invention concerns a building material with hydraulic binder comprising a fibrous or filament reinforcement. The reinforcement consists of synthetic yarns and fibres, modified by a dendritic polymer. The invention concerns for example fibre cements whereof the reinforcing fibers consist of a composition comprising a polyamide and a dendritic polymer.

The present invention relates to a building material based on a hydraulic binder, comprising a fibrous or filamentary reinforcement. It relates, for example, to fibre-cement materials whose fibres are polyamide-based.

The building and civil engineering industries use many forms of materials based on hydraulic binders: mortars, cements, concretes, plasters. These materials can be formed directly on site or can be formed beforehand in order to obtain prefabricated components, such as tiles or panels. Many materials used in these fields include reinforcing fibres or textile reinforcing surfaces.

One material particularly widely used is, for example, fibre-reinforced concrete. Other materials particularly widely used for the production of prefabricated components are fibre-cement materials. They consist of a cementitious matrix in which reinforcing fibres are dispersed. Components made of fibre-cement material comprise one or more layers of this material joined together.

It is known to use asbestos fibres as reinforcing fibres for materials based on hydraulic binders. However, these fibres are carcinogenic, their use is prohibited in certain countries and in any case they are tending to disappear.

Henceforth it is preferred to use organic fibres, such as polyvinyl alcohol fibres. These solution-spun fibres have a high modulus and a favourable interfacial behaviour with respect to the hydraulic binder. However, their manufacturing cost is high.

Thermoplastic fibres obtained by melt spinning generally have a lower manufacturing cost than polyvinyl alcohol fibres. This is especially the case with polyamide-based fibres. The use of conventional melt-spun fibres in building materials does not, however, allow satisfactory mechanical property levels to be achieved. It is believed that these fibres have too low a modulus and/or poor interfacial behaviour with respect to the hydraulic binder.

It is an object of the present invention to provide a novel material, comprising a matrix based on a hydraulic binder and a fibrous or filamentary reinforcement obtained by melt spinning, the mechanical properties of which are satisfactory, for example they are similar to those obtained with the use of polyvinyl alcohol fibres.

For this purpose, the invention provides a building material comprising a matrix based on a hydraulic binder, the said matrix optionally comprising granular elements, and a fibrous or filamentary reinforcement, characterized in that the fibrous or filamentary reinforcement consists of yarns, fibres or filaments obtained by melt spinning a material obtained by blending at least one of the following two compounds:

a thermoplastic polymer;

a macromolecular compound chosen from dendrimers, hyperbranched polymers and polymers with a star or partial star structure.

The material according to the invention comprises a matrix, based on a hydraulic binder, and a fibrous or filamentary reinforcement. Such structures in materials are conventional. For example, it is known to use asbestos or polyvinyl alcohol fibres to produce fibre-cement materials or reinforced concretes. It is also known to use metal fibres. The fibrous reinforcement may be added to the matrix, either directly on site or before the material is used on site, during the manufacture of a prefabricated component.

The matrix is based on a hydraulic binder. The term “hydraulic binder” is understood to mean a mineral material which hardens in the presence of water, such as cement and plaster. To implement the invention, cements are preferred. Most particularly, mention may be made of Portland cement, alumina cement and slag cement. Mention may also be made of gypsum, calcium silicates obtained by autoclaving, phosphate-based binders, sodium silicates and combinations of these binders. The hydraulic binder is mixed with water and optionally with additives and/or granular elements. The amount of water influences the rheology of the product and the solidification of the material. Any cementitious material can be used.

As examples of granular elements, mention may be made of sand, SiO₂, TiO₂, Al₂O₃, ZrO₂, Cr₂O₃, talc, mica, kaolin, wollastonite, bentonite, metakaolin, raw dolomite, chromium ore, limestone, clinker, vermiculite, perlite, gypsum, cellulose and slag. They may be synthetic products and may be crystalline or amorphous compounds obtained, for example, by grinding and screening to the desired size. It is also possible to use condensed silica fume, ground silica, pyrogenic silica and fly ash. A preferred mixture of mineral fillers according to the invention is a mixture which contains no or little siliceous-calcareous sand.

The fly ash that can be used is in general aluminosilicate ash coming from combustion, especially in thermal power stations.

The particle size of this ash is usually between 0.5 and 200 μm.

The condensed silica fume, optionally a constituent of the composition according to the invention, has in general a specific surface area of between 20 and 30 m²/g.

Most particularly, granular elements whose particle size is less than 0.5 mm are preferred. Preferably, they are used in a proportion of less than 250 parts by weight per 100 part of binder.

The additives optionally used may be intended to modify the properties of the material or to give the material properties allowing it to be incorporated into the manufacturing process. The material based on a hydraulic binder, preferably a cementitious material, may for example include organic compounds such as water-soluble or water-insoluble pulps, flocculants, such as polyethylene oxide, aluminium sulphate and polyacrylamide, latices, rheology modifiers, such as alginates and carboxymethylcellulose.

The material constituting the matrix, which optionally includes granular elements and/or additives, advantageously has an elastic modulus of less than 15 GPa. This is generally the case for materials which do not include granular elements or which include granular elements of fine particle size of less than 0.5 mm.

The reinforcement consists of fibres, yarns or filaments based on a synthetic thermoplastic polymer. The term “fibrous reinforcement” is understood to mean a reinforcement provided by individualized fibres of limited length. The term “filamentary reinforcement” is understood to mean a reinforcement provided by monofilaments, multifilament yarns or staple fibre yarns, which are present in the matrix in continuous form.

A fibrous reinforcement may be added to the matrix by mixing fibres into the mixture of water, hydraulic binder and optionally additives and/or granular elements, before the material hardens. According to another embodiment, the fibrous reinforcement is added in the form of a nonwoven surface onto which a mixture of water and hydraulic binder is poured, or which is deposited on the mixture of water and hydraulic binder, before hardening. According to another embodiment, a papermaking technique is used to obtain a relatively thin sheet comprising fibres dispersed in the matrix. The latter technique is, for example, used for the manufacture of prefabricated fibre-cement components.

A filamentary reinforcement may be added to the matrix in the form of a woven textile article or in the form of continuous yarns or filaments is supplied as they are in the material. For example, the reinforcement may consist of a fabric or cloth which is produced from monofilament or multifilament yarns, or from fibre yarns, and which is preferably open.

The reinforcement may also consist of continuous yarns or filaments. These are advantageously placed on a layer of unhardened hydraulic binder so as to have a preferred direction. The yarns or filaments may thus be arranged in a more or less regular manner, approximately parallel to one another. The continuous yarns or filaments are, for example, placed on the hydraulic binder layer by unwinding them from one or more wound packages or from a warp beam.

The yarns, fibres and filaments constituting the fibrous or filamentary reinforcement are obtained by melt spinning a thermoplastic. The melt spinning of yarns, fibres or filaments is known to those skilled in the art. The thermoplastic consists of at least two blended compounds:

a thermoplastic polymer;

a macromolecular compound chosen from dendrimers, hyperbranched polymers and polymers having a star or partial star structure.

The two components are preferably melt-blended, either by extrusion and then granulation, during an operation prior to spinning, or directly during the melting before spinning.

The thermoplastic polymer is preferably chosen from non-aromatic polyamides, polyesters, PVCs, acrylic polymers and polypropylene. Most particularly preferred are polymers whose macromolecular chains are capable of forming hydrogen bonds between them, especially polyamides, such as nylon-6,6, nylon-6, blends and copolymers based on these polyamides, and polyesters, such as polyethylene terephthalate and polytrimethylene terephthalate. The manufacture of yarns, fibres and filaments by melt spinning these polymers is known, and the spinning of the blends including the macromolecular compound is carried out under similar conditions.

The macromolecular compound is chosen from dendrimers, hyperbranched polymers and star or partial star polymers. Dendrimers and hyperbranched polymers are often grouped together under the name dendritic polymers.

The term “dendrimer” is understood to mean a polymeric structure having regular, arborescent and generally controlled branching, which may show symmetry. They are, for example, formed by arborescent growth of compounds having a functionality of greater than 2, the growth being initiated around a core molecule. Such structures are described, for example, in D. A. Tomalia, A. M. Naylor and W. A. Goddard III, Angewandte Chemie [Applied Chemistry], Int. Ed. Engl. 29, 138-175 (1990).

The term “hyperbranched polymer” is understood to mean a branched polymeric structure obtained by polymerization in the presence of compounds having a functionality of greater than 2, and whose structure is not perfectly controlled. They are often random copolymers. Hyperbranched polymers can, for example, be obtained by reaction between, especially, multifunctional, for example trifunctional, monomers and bifunctional monomers, each of the monomers bearing at least two different polymerization-reactive functional groups.

Dendritic polymers generally have a substantially globular shape with a size ranging from a few nanometres to several tens of nanometres. The branches of the molecular construction have ends whose functionality can be modified. By definition, the number of ends per macromolecule is greater than 2.

The term “star polymer” is understood to mean a polymeric structure obtained by growth of linear macromolecular chains around a multifunctional core monomer, the terminal functional groups of which are identical. The term “partial star” is understood to mean a compound comprising a blend of star macromolecular chains and linear macromolecular chains.

Among macromolecular compounds suitable for the invention, mention may be made of aromatic polyamide dendrimers, for example those described in Patent Applications WO 95/06080 and WO 95/06081: polyamidoamine dendrimers terminated by amine functional groups; polyethyleneimine dendrimers terminated by amine functional groups; polypropyleneimine dendrimers terminated by amine functional groups; polyamine dendrimers.

Special mention may also be made of polypropylene-amines having carboxylic functional groups, for example the compounds sold by DSM under the name ASTRAMOL™, polyamidoamines having carboxylic end groups, for example the compounds sold by Dendritech under the name STARBURST, and functionalized hyperbranched polyesters, for example succinic anhydride, of the type of those sold by Perstorp under the name BOLTORN. These compounds can be used as they are, or in functionalized form, with different terminal functional groups from those mentioned above, for example amine, ester or amide functional groups.

The macromolecular compounds used to implement the invention include a larger amount of terminal functional groups than linear polymers. Without wishing to be tied down to any particular theory, it is believed that the terminal functional groups have an important effect on the modification of the yarns, fibres or filaments constituting the fibrous or filamentary reinforcement and their behaviour with respect to the matrix.

Advantageously, the macromolecular compound has terminal functional groups capable of forming hydrogen bonds. These are, for example, carboxylic acid, amine, alcohol, ester or amide functional groups.

For a first category of macromolecular compounds, the terminal functional groups capable of forming hydrogen bonds are present following the process of synthesizing the compound. This is the case, for example, when one of the monomers carries such a functional group or a precursor of such a functional group.

For a second category of macromolecular compounds, the terminal functional groups capable of forming hydrogen bonds are obtained by postfunctionalization of a macromolecular compound not carrying the said terminal functional groups. This involves, for example, making a functionalizing agent having the desired functional group, which will become a terminal functional group, react with a macromolecular compound having a structure as described above.

The nature of the macromolecular compound used may be chosen according to the thermoplastic polymer and its spinning temperature. In this regard, macromolecular compounds with high thermal stability are preferred. This is especially the case with the aromatic dendrimers and hyperbranched copolyamides described below.

The preferred macromolecular compounds for implementing the invention are hyperbranched copolyesters and hyperbranched copolyamides. More particularly, the preferred polyamides are hyper-branched copolyamides which are not fully aromatic. Such compounds are described in the patent application filed in France on May 5, 1999 under the number 99/05885. They are, for example, obtained by reaction between:

at least one monomer of formula (I) below:

A—R—B_{f} (I)

in which A is a polymerization-reactive functional group of a first type, B is a polymerization-reactive functional group of a second type capable of reacting with A, R is a hydrocarbon-based species optionally containing heteroatoms and f is the total number of reactive functional groups B per monomer: f≧2, preferably 2≦f≦10;

and at least one bifunctional monomer of formula (II) below:

A′—R′—B′ or the corresponding lactams, (II)

in which A′, B′ and R′ have the same definition as that given above for A, B and R, respectively, in formula (I);

characterized in that the I/II molar ratio is defined as follows:

0.05<I/II

and preferably 0.125≦I/II≦2;

and in that at least one of the species R or R′ of at least one of the monomers (I) or (II) is aliphatic, cycloaliphatic or arylaliphatic.

According to one preferred embodiment, the hyperbranched copolyamide is characterized in that:

the hydrocarbon-based species R and R′ in the monomers (I) and (II), respectively, each comprise:

i. at least one linear or branched aliphatic radical;

ii. and/or at least one cycloaliphatic radical;

iii. and/or at least one aromatic radical comprising one or more aromatic rings;

iv. and/or at least one arylaliphatic radical,

it being possible for these radicals (i), (ii), (iii) and (iv) optionally to be substituted and/or to comprise heteroatoms;

and in that:

A or A′ is a reactive functional group of the amine or amine salt type or of the acid, ester, acid halide or amide type;

B or B′ is a reactive functional groups of the acid, ester, acid halide or amide type or of the amine or amine salt type.

Thus, the polymerization-reactive functional groups A, B, A′ and B′ which are more especially selected are those belonging to the group comprising carboxylic and amine functional groups.

The term “carboxylic functional group” is understood to mean any acid COOH, ester or anhydride functional group.

When A or A′ corresponds to an amine or an amine salt, then B or B′ represents an acid, an ester, an acid halide or an amide, and vice versa.

According to one advantageous variant, the hyperbranched polymer can consist of a mixture of several different monomers (I) and several different monomers (II), provided that at least one of these monomers is aliphatic, cycloaliphatic or arylaliphatic.

Besides the multifunctional monomers (I) and the bifunctional monomers (II), it may be envisaged to have a hyperbranched polymer according to the invention also comprising, as constituent elements, monofunctional or multifunctional monomers (III) of the “core” type and/or monofunctional monomers (IV) of the “chain stopper” type.

The “core”-type monomers optionally included in the hyperbranched copolyamide and/or ester according to the invention can be those of formula (III) below:

R¹(B″)ₙ (III)

in which:

R¹ is a substituted or unsubstituted hydrocarbon-based radical such as silicone, linear or branched alkyl, aromatic, alkylaryl, arylalkyl or cycloaliphatic which can comprise unsaturated groups and/or heteroatoms;

B″ is a reactive functional group of the same nature as B or B′;

n≧1, preferably 1≦n≦100.

The “chain stopper”-type monomers optionally included in the hyperbranched copolyamide according to the invention can be those of formula (IV):

R²—A″ (IV)

in which:

R² is a substituted or unsubstituted hydrocarbon-based radical such as silicone, linear or branched alkyl, aromatic, arylalkyl, alkylaryl or cycloaliphatic which can comprise one or more unsaturated groups and/or one or more heteroatoms;

and A″ is a reactive functional group of the same nature as A or A′.

According to one advantageous embodiment of the invention, at least some of the bifunctional monomers (II) are in prepolymer form.

This may likewise be the case as regards the “core”-type monomers (III) or even the “chain stopper”-type monomers (IV).

The radicals R¹ and R² can advantageously comprise functional groups that give the hyperbranched polymer specific properties. These functional groups do not react with the functional groups A, B, A′ or B′ during the polymerization of the HBPA.

According to one preferred embodiment of the invention, f=2 so that the monomer (I) is trifunctional: ARB₂, A=carboxylic acid functional group, B=amine functional group and R=aromatic radical.

The hyperbranched polymer obtained, according to the invention, from the monomers I and II, can be likened to arborescent structures which have a focal point formed by the functional group A and a periphery bearing end groups B. When they are present, the monomers (III) form cores. Advantageously, the hyperbranched polymer can include “chain stopper” monofunctional monomers (IV) located at the periphery of the dendrimers according to the invention.

Moreover, the bifunctional monomers (II) are spacers in the three-dimensional structure. They allow control of the branching density and are in particular the origin of the advantageous properties of the hyperbranched polymers according to the invention.

The monomers (III) and (IV) allow control of the molecular weight.

Advantageously, the monomer (I) is chosen, for example, from the group comprising:

5-aminoisophthalic acid,

6-aminoundecanedioic acid,

3-aminopimelic acid,

aspartic acid,

3,5-diaminobenzoic acid,

3,4-diaminobenzoic acid,

lysine,

and mixtures thereof.

Advantageously and for example, the bifunctional monomer of formula (II) is:

ε-caprolactam and/or the corresponding amino acid: aminocaproic acid,

and/or para- or meta-aminobenzoic acid,

and/or 11-aminoundecanoic acid,

and/or lauryllactam and/or the corresponding amino acid: 12-aminododecanoic acid.

More generally, bifunctional monomers of formula (II) can be the monomers used for the manufacture of linear thermoplastic polyamides. Thus, mention may be made of ω)-aminoalkanoic compounds comprising a hydrocarbon-based chain containing from 4 to 12 carbon atoms, or lactams derived from these amino acids, such as ε-caprolactam.

The preferred bifunctional monomer (II) of the invention is ε-caprolactam.

As examples, the monomers (III) may themselves be:

saturated aliphatic dicarboxylic acids containing from 6 to 36 carbon atoms, such as, for example, adipic acid, azelaic acid, sebacic acid or dodecanoic acid,

biprimary diamines, preferably linear or branched saturated aliphatic biprimary diamines containing from 6 to 36 carbon atoms, such as, for example, hexamethylenediamine, trimethylhexamethylene-diamine, tetramethylenediamine or n-xylenediamine,

polymer compounds such as the amino polyoxyalkylenes sold under the brand name JEFFAMINE®,

or an aminosilicone chain, e.g. mono- or diamino polydimethylsiloxane,

aromatic or aliphatic monoamines,

aromatic or aliphatic monoacids, or

aromatic or aliphatic triamines or triacids.

The preferred “core” monomers (III) are: hexamethylenediamine and adipic acid, JEFFAMINE® T403 or 1,3,5-benzenetricarboxylic acid.

According to another characteristic of the invention, the molar ratio of the monomers (IV) to the bifunctional monomers (I) is defined as follows:

$$\frac{IV )}{( I )} \leq 10$$

preferably

$$\frac{IV )}{( I )} \leq 5$$

and even more preferably

$$0 \leq \frac{( IV )}{( I )} \leq 2.$$

As regards #17 the molar ratio of the “core” functional monomers (III) to the multifunctional monomers (I), this may be defined as follows:

$$\frac{III )}{( I )} \leq 1$$

preferably

$$\frac{III )}{( I )} \leq 1 / 2$$

and even more preferably

$$0 \leq \frac{( III )}{( I )} \leq 1 / 3.$$

Advantageously, the hyperbranched copolyamide can be in the form of particles each consisting of one or more arborescent structures. Another advantageous characteristic of such a copolyamide is the fact that it can be functionalized:

at the focal point of the arborescent structure(s), via monomers (III) bearing the functional group or groups under consideration,

and/or at the periphery of the arborescent structures, via monomers (IV) bearing the functional group or groups under consideration.

As regards the synthesis aspect, it should be pointed out that the hyperbranched copolyamides can be obtained by a process characterized in that it consists essentially in carrying out a polycondensation between monomers (I) and monomers (II) which react together and optionally with monomers (III) and/or (IV), this taking place under suitable temperature and pressure conditions. This polymerization is performed in the melt phase, in the solvent phase or in the solid phase, preferably in the melt phase or the solvent phase, the monomer (II) advantageously acting as solvent.

The process for synthesizing the hyperbranched polymers of the invention can use at least one polycondensation catalyst.

The polycondensation polymerization is carried out, for example, under conditions and according to a procedure which are equivalent to those used for the manufacture of the linear polyamide corresponding to the monomers (II).

The proportion by weight of macromolecular compound in the blend is preferably between 0.1 and 50%. The optimum proportion of compound depends in general on its nature and on the nature of the matrix.

The material according to the invention can be obtained by several processes known to those skilled in the art in the building and civil engineering fields or in the field of the manufacture of prefabricated building components.

The material may, for example, be obtained by mixing the solid constituents with water, forming (moulding, casting, injection moulding, pumping, spraying, extrusion or calendering) and then hardening. Thus, the process may be carried out by bringing together all the components of the mixture, either simultaneously or separately. According to the latter option, in general a composition is prepared which comprises the hydraulic binder, the fibres according to the invention constituting the reinforcement and, where appropriate, additives and/or granular elements. Next, this composition is mixed with water.

According to one preferred embodiment, the material is a fibre-cement material, that is to say a material whose hydraulic binder is a cement and whose fibrous reinforcement consists of fibres dispersed in the matrix by a papermaking technique. In short, this technique consists in making a suspension of fibres in a mixture of water and cement with, optionally, granular elements and/or additives, in extracting the water so as to obtain a sheet of a material comprising unhardened cement and fibres, the fibres giving the sheet a certain cohesion, and then in hardening the material. Such materials may, in particular, be obtained by Hatschek machines widely used to manufacture prefabricated building components.

Hatschek machines comprise at least one applicator roll and a conveyor belt. The roll is in contact with the conveyor belt and part of the roll is immersed in a tank containing a mixture of water, fibres and cement, the water being in excess. The fibres are suspended in the mixture. The roll is intended for picking up the mixture, depleted of water, from the tank onto the conveyor belt. The machine includes means for extracting the water through the roll by suction. The material, based on a hydraulic binder in which the fibres are dispersed, depleted of water, is picked up onto the suction roll and deposited on the conveyor belt at the point where the roll and the conveyor belt come into contact with each other. Thus, a ply of an unhardened material, called a reinforced cementitious sheet, is deposited on the conveyor belt. The proportion by weight of water in the reinforced cementitious sheet is, for example, about 30%. Hatschek machines are known to those skilled in the art. They are described, for example, in Patent AT 5970, Patent FR 2 387 920 and U.S. Pat. No. 4,428,775.

The mixture containing the water, cement and fibres, and optionally the additives and/or granular elements, advantageously contains a compound intended to modify the rheology and the draining of the mixture, in particular making it possible to prevent the binder from being entrained with the water extracted into the roll. Suitable compositions are, for example, described in Patent FR 2 476 534 and in Patent FR 2 448 516. Mention may be made, for example, of water-soluble and/or emulsifiable polymers to which metal compounds are added. The water-soluble or water-emulsifiable polymers may be alginates, polyacrylamides, polyvinyl alcohols, polysaccharides or polypeptides. Water-soluble acrylamide polymers having a broad molecular weight range and a broad saponification index range are most particularly recommended. It is also possible to use acrylate emulsions. To ensure that the aqueous acrylic emulsions can be properly flocculated, it is preferable for these emulsions to actually flocculate within a basic dispersion of cement, for example using anionic emulsifying systems, which are incompatible with calcium ions. Preferably, the metal compounds are metal sulphates, such as aluminium sulphate or iron sulphate. These compounds may be chosen from cellulose pulp, water-soluble or water-emulsifiable polymers, such as polyacrylates, polyacrylamides, polyvinyl alcohols and polyethylene oxides. The cementitious material may also include a sulphate or hydroxide of a divalent metal ion, such as iron II sulphate, or aluminium sulphate.

As compounds intended to modify the rheology and the draining, mention may also be made of cellulose fibres, and in particular cellulose fibres pretreated by immersing them in a solution containing a compound chosen from metal hydroxides and/or sulphates, such as iron sulphate or calcium hydroxide, or by spraying these solutions onto the fibre. One treatment consists, for example, in precipitating aluminium hydroxide and calcium sulphate on cellulose fibres, by treating the latter with an aqueous aluminium sulphate solution to which calcium hydroxide is added subsequently.

The reinforcing fibres dispersed in the mixture preferably have a length of between 1 and 50 mm. Advantageously, they have a linear density of between 0.5 and 100 dtex.

Preferably, the reinforced cementitious sheet is relatively thin, for example having a thickness of between 0.1 and 100 mm and preferably between 1 and 10 mm. It is placed on the conveyor belt. At this stage of the process, the sheet is relatively pliant, the cement not having fully hardened. It will be fully hardened later.

The reinforced cementitious sheet is produced continuously on the conveyor belt. It will undergo subsequent operations of cutting, possibly of assembly, and of curing.

The conveyor belt is driven continuously, for example by drive rollers. The various components making up the reinforced sheet are deposited, at various points, simultaneously or in succession. The reinforced cementitious sheet is drawn off from the conveyor belt at a point downstream from the point where the reinforced cementitious material is deposited on the conveyor belt. The cementitious sheet is, for example, taken up over a roll.

The cementitious sheet obtained is converted and handled during a subsequent phase so as to obtain an end product. For example, the sheet may be taken off the conveyor belt, cut up and consolidated, for example by compression, and then hardened by thermal curing or maturation. A single-ply article is therefore obtained.

The sheet may be wound onto a roll, before final curing, so as to obtain an assembly consisting of several thicknesses, for example between 2 and 10 thicknesses. When the desired number of thicknesses is reached, the sheet is cut at the roll through all the thicknesses, and a product which is not fully hardened, consisting of several plies, is recovered. This product is then hardened, for example by compression, curing or maturation. Before or during final hardening, the product may be given a particular shape and a surface texture, by pressing it onto a support of suitable shape. In this way it is possible, for example, to obtain corrugated shapes. The articles obtained may be cut to the dimensions of the end article before or after the final hardening.

The invention also relates to prefabricated building components of the fibre-cement type, capable of being obtained by the process described above. In particular, mention may be made of tiles, panels and tanks.

The materials and the prefabricated components according to the invention exhibit excellent mechanical properties. These properties are superior to those obtained using conventional melt-spun fibres and in certain cases they are more or less equivalent to those obtained using high-modulus solution-spun fibres, such as PVA (polyvinyl alcohol) fibres.

Further details and advantages of the invention will become more clearly apparent in the light of the following examples, given solely by way of indication.

### EXAMPLE 1

### Synthesis of a Hyperbranched Copolyamide Having Amine End Groups by Melt Copolycondensation of JEFFAMINE® T 403 (Core Molecule of the R¹—B″₃ type, Where B″═NH₂), of 3,5-Diaminobenzoic Acid (Branching Molecule of the A—R—B₂ Type, Where A═COOH and B═NH₂ and of ε-Caprolactam (Spacer of the A′—R′—B′ Type, Where B′═NH₂ and A′═COOH)

The reaction was carried out at atmospheric pressure and under a gentle flush of nitrogen in a 1 l autoclave commonly used for the melt synthesis of polyesters or polyamides.

All the monomers were loaded together at the start of the trial. 322.5 g of 3,5-diaminobenzoic acid (2.12 mol), 239.9 g of ε-caprolactam (2.12 mol), 37.3 g of JEFFAMINE® T403 (0.085 mol), 4 g of 5-tert-butyl-4-hydroxy-2-methylphenyl sulphide (ULTRANOX® 236) and 1.1 ml of an aqueous 50% (w/w) solution of hypophosphorous acid were introduced in succession into the reactor. The reactor was purged by a succession of 4 sequences of creating a vacuum and of re-establishing atmospheric pressure using dry nitrogen.

The reaction mass was gradually heated from 20 to 200° C. over 100 minutes, then from 200 to 230° C. over 60 minutes and finally held at 2300 for 180 minutes. When the temperature of the mass reached 100° C., the stirring was started at a rotation speed of 50 revolutions per minute. The distillation started at a temperature of 215° C. After 180 minutes at 230° C., the stirring was stopped and the reactor placed under an excess pressure of nitrogen. Next, the bottom valve was gradually opened and the polymer run off into a stainless steel container filled with water. Next, the polymer was dried under the vacuum of a vane pump for 16 hours. It was then reduced to powder using a blade mill and a mesh in the presence of dry ice.

### EXAMPLE 2

### Production of Fibres Comprising the Copolyamide According to Example 1

Granules of a composition, including 3% by weight of the copolyamide according to Example 1 in a polyamide matrix, were produced by extrusion in a twin-screw extruder with double feed, namely matrix (granules) feed and additive (powder) feed. The matrix was TECHNYL 140CP80, a nylon-6 sold by Rhodia Engineering Plastics.

Yarns were melt spun from the granules produced, through a 13-hole spinneret, each hole having a diameter of 250 lm. The spinning, of the POY type, was at 4500 m/min; the yarn was taken up on a BARMAG SW46 wind-up after passing over two rollers. The spinning behaviour was deemed to be very good. The spinning was followed by drawing with uptake of the yarn on a Dienes drawing rig at a rate of 450 m/min, down to an approximately 44f/13 dtex final linear density. The yarns thus obtained were then chopped in order to give fibres having a length of approximately 6 mm.

### EXAMPLE 3 (COMPARATIVE EXAMPLE)

### Production of Fibres Made of Polyamide Without an Additive

Fibres according to a process identical to that described in the case of Example 2, but without the addition of the hyperbranched copolyamide, where produced.

The mechanical properties of the fibres were measured on an Instron tensile testing machine at room temperature. E₂% denotes the 2% secant modulus, εₘₐₓ denotes the elongation at break and σₘₐₓ denotes the nominal breaking stress. The exact linear density was determined by weighing. The results are given in Table I.

TABLE I

| | Linear | | | |
|---|---|---|---|---|
| Example | density | E_{2%} | εₘₐₓ | σₘₐₓ |
| 2 | 44f/13 dtex | 490 cN/tex | 12% | 55 cN/tex |
| | | (5.6 GPa) | | (630 MPa) |
| 3 | 40f/13 dtex | 510 cN/tex | 14% | 43 cN/tex |
| | | (5.8 GPa) | | (490 MPa) |

### EXAMPLES 4, 5 AND 6

### Production of Fibre-Cement Material

A fibre-cement material was produced. It was obtained using the following raw materials:

cement: 52.5: HTS (high silica content) Portland cement supplied by Lafarge;

silica fume: fume from the ferrosilicon industry: 940 U supplied by Elkem;

cellulose: SG 15-16 short-fibre grade, supplied by Rhodia Acetow, Brazil;

defoamer: 6352 DD grade powder, supplied by Bevaloid.

The trials were carried out with a base matrix to which various types of reinforcing fibres were added: the composition of the matrix was the following:

| | | |
|---|---|---|
| cellulose fibres | 4% | (10 g) |
| silica fume | 14% | (35 g) |
| cement | 80% | (200 g) |
| defoamer | 0.5% | (1 g) |
| water | 750 g | (w/c = 3.75). |

Reinforcing fibres were incorporated at various levels (1% to 5%).

The cellulose was depulped with a portion of the water and the reinforcing fibres were incorporated into this pulp.

The fibres, reinforcing fibres and cellulose fibres were then mixed with the rest of the water for a minimum of 10 minutes using a screw mixer (2000 revolutions/minute); the other products were then incorporated in one go. The mixture was then homogenized for five minutes (approximately 2000 revolutions/minute).

Next, the mixture was filtered so as to reduce the water content: a cake having a water/cement ratio of about 0.5 was thus obtained. Vacuum filtration may be used to speed up the process.

The cake obtained was cut with a cutting tool or compressed directly, so as to produce test specimens having the dimensions of 30×120 mm (approx. 50 g of slurry). The test specimens were placed gently in metal moulds having the same dimensions (30×120 mm) and then compressed for 5 minutes at a pressure of 4 tonnes and then 5 minutes at a pressure of 8 tonnes. The test specimens were demoulded carefully and conditioned for a minimum of 12 h at 20° C. in a dry bag or for 24 hours at 20° C. in a bag with saturated humidity. Next, the test specimens were thermally cured between 60 and 90° C. at 95% humidity for 24 to 48 hours.

The mechanical properties of the fibre-cement materials were measured in bending on a 3-point bending test machine (distance between supports: L=80 mm) at a test speed of 0.5 mm/min. The breaking stress of and the elastic modulus (Young's modulus) E were measured:

breaking stress σ_{f}:

σ=3FL/(2bh²) where h=specimen height

b=specimen width

F=applied load

elastic modulus (Young's modulus) E:

E=L³F/(4bh³y) where y is the deflection corresponding to the load F.

The test specimens were preconditioned for a minimum of 24 hours at 23° C. (±3° C.).

### EXAMPLE 4

A fibre-cement material, comprising 2% by weight, with respect to the total of the dry products, of reinforcing fibres according to Example 2, having a linear density of 3.4 dtex and a length of 6 mm, were produced using the method described above. The properties of the fibre-cement material are given in Table II.

### EXAMPLE 5 (COMPARATIVE EXAMPLE)

A fibre-cement material, comprising 2% by weight, with respect to the total of the dry products, of reinforcing fibres according to Example 3, having a linear density of 3.1 dtex and a length of 6 mm, were produced using the method described above. The properties of the fibre-cement material are given in Table II.

### EXAMPLE 6 (COMPARATIVE EXAMPLE)

A fibre-cement material, comprising 2% by weight of polyvinyl alcohol fibres, was produced using the same method as described above, the fibres having the following characteristics:

fibres: APV RM182, supplied by Kuraray

linear density: 3.3 dtex;

length: 6 mm.

The properties of the fibre-cement material are given in Table II.

TABLE II

| | Example | | |
|---|---|---|---|
| | 4 | 5 | 6 |
| Elastic modulus | 10 | 10 | 12 |
| (GPa) | | | |
| Breaking stress | 17 | 12 | 18 |
| (MPa) | | | |

FIG. 1 shows the stress-strain curves obtained for the various compositions corresponding to Examples 4, 5 and 6.

1. Building material comprising a matrix based on a hydraulic binder, the said matrix optionally comprising granular elements, and a fibrous or filamentary reinforcement, characterized in that the fibrous or filamentary reinforcement consists of yarns, fibres or filaments obtained by melt spinning a material obtained by blending at least one of the following two compounds:
a thermoplastic polymer;
a macromolecular compound chosen from dendrimers, hyperbranched polymers and polymers with a star or partial star structure.

2. Material according to claim 1, characterized in that the macromolecular compound has terminal functional groups capable of forming hydrogen bonds, and in that the thermoplastic polymer is chosen from polymers whose macromolecular chains form hydrogen bonds between them.

3. Material according to claim 1, characterized in that the macromolecular compound is a hyperbranched copolyamide obtained by reaction between:
at least one monomer of formula (I) below:
A—R—B_{f} (I)
in which A is a polymerization-reactive functional group of a first type, B is a polymerization-reactive functional group of a second type capable of reacting with A, R is a hydrocarbon-based species optionally comprising heteroatoms and f is the total number of reactive functional groups B per monomer: f≧2, preferably 2≦f≦10;
and at least one bifunctional monomer of formula (II) below:
A′—R′—B′ or the corresponding lactams, (II)
in which A′, B′ and R′ have the same definition as that given above for A, B and R, respectively, in formula (I);
characterized in that the I/II molar ratio is defined as follows:
0.05>I/II
and preferably 0.125≦I/II≦2;
and in that at least one of the species R or R′ of at least one of the monomers (I) or (II) is aliphatic, cycloaliphatic or arylaliphatic.

4. Material according to claim 3, characterized in that:
the hydrocarbon-based species R and R′ in the monomers (I) and (II), respectively, each comprise:
i. at least one linear or branched aliphatic radical;
ii. and/or at least one cycloaliphatic radical;
iii. and/or at least one aromatic radical comprising one or more aromatic rings;
iv. and/or at least one arylaliphatic radical;
it being possible for these radicals (i), (ii), (iii) and (iv) optionally to be substituted and/or to comprise heteroatoms;
and in that:
A or A′ is a reactive functional group of the amine or amine salt type or of the acid, ester, acid halide or amide type;
B or B′ is a reactive functional group of the acid, ester, acid halide or amide type or of the amine or amine salt type.

5. Material according to either of claims 3 and 4, characterized in that at least some of the bifunctional monomers (II) is in the form of a prepolymer.

6. Material according to one of claims 3 to 5, characterized in that the polymerization-reactive functional groups A, B, A′ and B′ are chosen from the group comprising carboxylic and amine functional groups.

7. Material according to one of claims 3 to 6, characterized in that it includes “core” monomers of formula (III):
R¹(B″)ₙ (III)
in which:
R¹ is a substituted or unsubstituted hydrocarbon-based radical such as silicone, linear or branched alkyl, aromatic, alkylaryl, arylalkyl or cycloaliphatic which can comprise unsaturated groups and/or heteroatoms;
B″ is a reactive functional group of the same nature as B or B′;
n≧1, preferably 1≦n≦100.

8. Material according to one of claims 3 to 7, characterized in that it includes “chain stopper” monomers of formula (IV):
R²—A″ (IV)
in which:
R² is a substituted or unsubstituted hydrocarbon-based radical such as silicone, linear or branched alkyl, aromatic, arylalkyl, alkylaryl or cycloaliphatic which can comprise one or more unsaturated groups and/or one or more heteroatoms;
and A″ is a reactive functional group of the same nature as A or A′.

9. Material according to one of claims 3 to 8, characterized in that the monomer or formula (I) is a compound in which A represents the carboxylic acid functional group, B the amine functional group and R an aromatic radical, and f=2.

10. Material according to one of claims 3 to 9, characterized in that the monomer (I) is chosen from the group comprising:
5-aminoisophthalic acid,
6-aminoundecanedioic acid,
3-aminopimelic acid,
aspartic acid,
3,5-diaminobenzoic acid,
3,4-diaminobenzoic acid,
lysine,
and mixtures thereof.

11. Material according to one of claims 3 to 10, characterized in that the bifunctional monomer of formula (II) is:
ε-caprolactam and/or the corresponding amino acid: aminocaproic acid,
and/or para- or meta-aminobenzoic acid,
and/or 11-aminoundecanoic acid,
and/or lauryllactam and/or the corresponding amino acid:
12-aminododecanoic acid.

12. Material according to one of claims 3 to 11, characterized in that the molar ratio of the monomers (IV) to the bifunctional monomers (I) is defined as follows:
$$\frac{IV )}{( I )} \leq 10$$
preferably
$$\frac{IV )}{( I )} \leq 5$$
and even more preferably
$$0 \leq \frac{( IV )}{( I )} \leq 2.$$
and in that the molar ratio of the “core” functional monomers (III) to the multifunctional monomers (I) may be defined as follows:
$$\frac{III )}{( I )} \leq 1$$
preferably
$$\frac{III )}{( I )} \leq 1 / 2$$
and even more preferably
$$0 \leq \frac{( III )}{( I )} \leq 1 / 3.$$

13. Material according to one of claims 3 to 12, characterized
in that it is in the form of particles each consisting of one or more arborescent structures;
and in that it is functionalized at the focal point of the arborescent structure(s), via monomers (III) bearing the functional group or groups under consideration, and/or at the periphery of the arborescent structures, via monomers (IV) bearing the functional group or groups under consideration.

14. Material according to one of the preceding claims, characterized in that the thermoplastic polymer is chosen from nylon-6, nylon-6,6, copolymers and blends of polymers based on these polyamides.

15. Material according to one of the preceding claims, characterized in that the proportion by weight of macromolecular compound in the blend is between 0.1 and 50%.

16. Material according to one of the preceding claims, characterized in that the fibrous or filamentary reinforcement consists of yarns, fibres or filaments whose elastic modulus is greater than 4 GPa and preferably 5 GPa.

17. Material according to one of the preceding claims, characterized in that the matrix based on a hydraulic binder is chosen from plasters, cements and materials based on plasters and cements, including granular elements of size smaller than 500 μm.

18. Material according to one of the preceding claims, characterized in that the elastic modulus of the matrix, in the absence of the fibrous or filamentary reinforcement, has an elastic modulus of less than 15 GPa.

19. Material according to one of the preceding claims, characterized in that the binder is a cement and in that the reinforced material is obtained by a papermaking technique using a Hatschek machine.

20. Material according to claim 19, characterized in that the proportion by weight of fibrous or filamentary reinforcement in the material is between 0.5 and 5%.

21. Material according to either of claims 19 and 20, characterized in that the reinforcement consists of fibres whose length is between 1 and 50 mm and whose linear density is between 0.5 and 100 dtex.

22. Prefabricated building component of the fibre-cement type, consisting of a material according to one of claims 19 to 21.
